(19) United States
(12) Patent Application Publication
(10) Pub. No.: US 2017/0258103 A1
(43) Pub. Date: Sep. 14, 2017

(54) PROCESSES FOR PRODUCING TREATED MILK PRODUCTS

(71) Applicant: SELECT MILK PRODUCERS, INC., ARTESIA, NM (US)

(72) Inventors: Mike MCCLOSKEY, Fair Oaks, IN (US); Mark BOYTIM, Coopersville, MI (US)

(73) Assignee: SELECT MILK PRODUCERS, INC., ARTESIA, NM (US)

(21) Appl. No.: 15/310,335

(22) PCT Filed: May 13, 2015
(86) PCT No.: PCT/US2015/030647

§ 371 Date: Nov. 10, 2016

Related U.S. Application Data
(60) Provisional application No. 61/992,539, filed on May 13, 2014.

(51) Int. Cl. A23C 9/15; A23C 3/037; A23C 9/142; A23C 3/033

(52) U.S. Cl. CPC A23C 9/15; A23C 3/033; A23C 3/037; A23C 9/1427

(57) ABSTRACT

Provided is a process for producing a concentrated or a concentrated and sterilized milk composition, including subjecting the composition to multi-stage recirculating reverse osmosis, where during recirculating reverse osmosis (RRO), for at least part of the RRO process, a step in the RRO process, or during the entire RRO process, the RRO process is carried out at a temperature of from greater than 45° F. to 60° F., where water is removed, to produce a concentrated milk composition. The concentrated milk composition can optionally be sterilized by first heating the concentrated composition to a first elevated temperature of from 175° F. to 185° F. (and in some cases to 210° F.) within a time period of 45 seconds to produce a first heated composition.

### CROSS-REFERENCE

This application claims benefit under 35 U.S.C. §119(e) of U.S. Provisional Application No. 61/992,539, filed on May 13, 2014, the content of which is hereby incorporated by reference in its entirety.

### FIELD

The presently described subject matter relates to an improved process for concentrating and heat treating liquid milk products. Such processes can include concentrating and/or heat treating liquid food products based on milk.

### BACKGROUND

It is known that the storage life of cream, milk and other liquid milk products is often very short when these products are stored at ambient temperature, e.g. 10° C. to 40° C., and that the shelf-life of such products can be prolonged by storing the products under refrigerated conditions, e.g. 5° C. to 10° C. Such refrigeration prolongs the shelf-life of the liquid milk products by up to 10-20 days.

The deterioration in the quality of liquid milk products such as cream and milk is due to enzymatic and microbiological activity that normally develops within a few days following storage to a level such that the product takes on unacceptable flavor characteristics and frequently undergoes unacceptable physical changes. The enzymatic and microbiological activity that gives rise to these unacceptable changes is not prevented by conventional pasteurization treatment and it has been proposed to subject dairy products to higher temperature heat treatments in order to inhibit this enzymatic and microbiological activity. Such heat treatment may involve flash-heating above 139° C. for very short periods of time, the so-called ultra high temperature (UHT) treatment. Milk can be made commercially sterile by subjecting it to temperatures in excess of 100° C., and packaging it in air-tight containers. The milk may be packaged either before or after sterilization. The basis of UHT, or ultra-high temperature, is the sterilization of food before packaging, then filling into pre-sterilized containers in a sterile atmosphere. Products which have been heat-treated in this way have prolonged shelf-lives of several months. However, products treated in this manner suffer from the severe disadvantage that they lose their natural, fresh taste and take on a characteristic burnt taste that is less attractive to the consumer.

Shelf stable and aseptic concentrate milks available in the market place today use a condensing technology (heat and vacuum) to reduce the water content of the starting milk material that involves the use of a pre-heat treatment or pasteurization. They are traditionally sold as “condensed milks” packaged in cans or packages. These products are condensed by a heating process and as a result, there is substantial damage to the structure of the milk, which affects the ability of the concentrated product to be rehydrated. Furthermore, condensation by heating results in a lowering of pH (increase in acidity), which makes the concentrated product unsuitable for UHT or sterilization treatment, and damages the structural integrity of the product. Additionally, the increased acidity of heat-based concentrated products results in coagulation or gelation of the milk components, for e.g., milk proteins.

Additionally, the flavor profile of the heat-concentrated product is different from that of the raw milk or skim milk starting material. Since these products typically have additional heat applied to them by the UHT pasteurization process, they acquire a “burnt” or “sterilized” flavor that is disfavored by consumers.

### SUMMARY

The presently described subject matter is directed to a process for concentrating a compositing comprising milk or a milk product, for example, skim milk, using recirculating reverse osmosis (RRO) where at least a part of the process is carried out at a temperature of from greater than 45° F. to 60° F. The produced concentrated composition can contain greater than 26 wt % solids-not-fat (SNF) up to 40 wt % SNF. The process can optionally be coupled with a sterilization process comprising heat-treating. The heat-treatment temperature and time of exposure inhibits microbiological activity in the treated product when it is stored in hermetically sealed containers at 10° C. to 40° C. (50° F.-104° F.) for long periods of time while, at the same time, producing a product that is acceptable to the consumer.

The presently described subject matter is directed to a concentrated, sterilized milk product produced by the presently described process.

The presently described subject matter is directed to a process for producing a concentrated and sterilized composition, comprising or consisting of concentrating a composition comprising or consisting of milk or a milk product comprising or consisting of subjecting the composition to multi-stage recirculating reverse osmosis at a temperature of from greater than 45° F. to 60° F. at a pressure of from 200 psi to 700 psi, wherein water is removed from the composition to produce a concentrated composition; and sterilizing the concentrated composition comprising or consisting of first heating the concentrated composition that is at a temperature of from greater than 45° F. to 60° F. to a first elevated temperature of from 175° F. to 185° F. (and in some cases to 210° F.) within a time period of 45 seconds to produce a first heated composition.

The presently described subject matter is directed to any of the presently described processes wherein the volume of the concentrated composition is no more than 50% of the volume of the composition.

The presently described subject matter is directed to any of the presently described processes, wherein the composition is skim milk.

The presently described subject matter is directed to any of the presently described processes, further comprising after concentrating, adjusting the total solids content of the concentrated composition.

The presently described subject matter is directed to any of the presently described processes, wherein the concentrated composition comprises from 28 to 34 wt % of solids-not-fat (SNF).

The presently described subject matter is directed to any of the presently described processes, further comprising after the first heating, second heating the first heated composition from the first elevated temperature to a second elevated temperature.

The presently described subject matter is directed to any of the presently described processes, wherein the second heating is to a second elevated temperature of from 283° F. to 295° F. within a time period of less than 6 seconds to produce a second heated composition.

The presently described subject matter is directed to any of the presently described processes, further comprising holding the second heated composition at the second elevated temperature for at least 4 seconds.

The presently described subject matter is directed to any of the presently described processes, further comprising cooling the second heated composition comprising or consisting of evaporating the second heated composition.

The presently described subject matter is directed to a process for producing a concentrated composition, comprising or consisting of subjecting the composition to multi-stage recirculating reverse osmosis at a temperature of from greater than 45° F. to 60° F. at a pressure of from 200 psi to 700 psi, wherein water is removed from the composition to produce a concentrated composition having a solids-not-fat content of from 28 wt % to 34 wt %.

The presently described subject matter is directed to any of the presently described processes, further comprising sterilizing the concentrated composition.

The presently described subject matter is directed to any of the presently described processes, wherein sterilizing comprises or consists of first heating the concentrated composition that is at a temperature of from greater than 45° F. to 60° F. to a first elevated temperature of from 175° F. to 185° F. (and in some cases to 210° F.) within a time period of 45 seconds to produce a first heated composition.

The presently described subject matter is directed to a concentrated and sterilized composition produced by any presently described process.

### BRIEF DESCRIPTION OF DRAWINGS

FIG. 1 is a diagram showing an RRO process produce a dairy product according to the presently described subject matter. The diagram includes a magnetic flow meter used to measure feed and concentrate flow and then set a ratio between these two flows so that the back pressure valve is also controlled. Thus, concentration flows out of the system and solids to the down-stream process, can also be controlled.

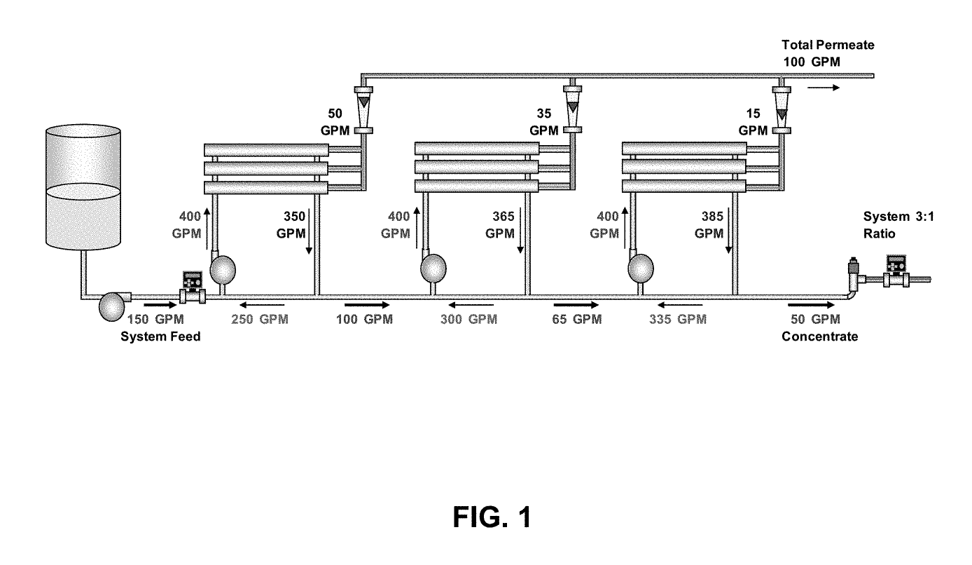

FIG. 2 shows a flow chart for processing Holstein milk.

### DETAILED DESCRIPTION

### Definitions

The term “about” as used herein refers to a quantity, level, value, dimension, size, or amount that varies to some extent based on the context in which it is used. For example, such variation can be by as much as 5%. At the least, each numerical parameter can be construed in light of the number of reported significant digits and by applying ordinary rounding techniques.

As used herein, the term “casein” generally encompasses casein per se (i.e., acid casein) or water soluble salts thereof, such as caseinates (e.g., calcium, sodium, or potassium caseinates, and combinations thereof). Casein amounts and percentages described herein are reported based on the total amount present of casein and caseinate (excluding the metal cation amount thereof). Casein generally relates to any, or all, of the phosphoproteins in milk, and to mixtures of any of them. An important characteristic of casein is that it forms micelles in naturally occurring milk. Many casein components have been identified, including, but not limited to, α-casein (including αs1-casein and αs2-casein), β-casein, γ-casein, κ-casein, and their genetic variants.

As used herein, the term “fat free milk” or “skim milk” each refer to milk having a milk fat content of 0.3 wt % or less, for example, 0.3 wt %, 0.2 wt %, or 0.1 wt %.

As used herein, the term “liquid milk product” refers to any milk or milk product as presently described, in liquid form.

As used herein the term “milk” includes any milk or milk product, including, but not limited to whole milk, skim milk, fat-free milk, low fat milk, full fat milk, lactose-free or lactose-reduced milk (produced by hydrolyzing the lactose by lactase enzyme to glucose and galactose, or by other methods such as nanofiltration, electrodialysis, ion exchange chromatography and centrifugation technology), concentrated milk, or any liquid component derived therefrom. Fat-free milk is a nonfat or skim milk product, that can, for example, contain not more than 0.3 wt % milk fat, not more than 0.2 wt % milk fat, or not more than 0.1 wt % milk fat. Low-fat milk is milk that contains from about 1% to about 2% fat. Full fat milk can contain about not less than 3.25% fat, and can contain about 8.25 SNF. As used herein, the term “milk” is also intended to encompass milk from animal and plant sources. Animal sources of milk include, but are not limited to, human, cow, sheep, goat, buffalo, camel, llama, mare, and deer. Plant sources of milk include, but are not limited to, milk extracted from soy bean, coconut, and/or almonds. In addition, the term “milk” refers to not only whole milk, but also skim milk or any liquid component derived therefrom. By “whey” or “milk serum” is meant the milk component remaining after all or a substantial portion of the milk fat and casein contained in milk are removed.

As used herein, the term “milk products” refers to milk as presently described or any composition containing milk or derived from milk, used in the presently described processes. Such milk and/or milk products can be standardized or non-standardized.

As used herein, the term “milk plasma” refers to the portion of raw milk remaining after removal of the fat content.

As used herein, the term “raw milk” refers milk that has not yet been processed, for example, has not yet been thermally processed.

As used herein, the term “fresh milk” refers milk that has not yet been processed, and is less than 24 hours old.

As used herein, the term “reverse osmosis” (RO) refers to pressure driven membrane filtration where hydraulic force is applied in excess of the natural osmotic pressure of a solution to provide the driving energy for water molecules to diffuse into and through the membrane.

Reverse osmosis systems can include a pressure vessel which is a sealed hollow tube that houses the RO membrane elements. To force a liquid through a semi-permeable membrane, pressure must be applied to overcome the feed stock's, i.e., milk or milk product, osmotic back pressure and permeate back pressure. Pumps are required to push the feed stock's through the RO system. They must be sized to meet the required operating pressure and flow rate of the system and they constitute largest energy consuming component in the system. Valves are required to control the flows and pressures of an RO system for the system to operate correctly and optimally.

As used herein, the term “reverse osmosis membrane” refers to the membrane that resides within a pressure vessel. Such reverse osmosis membranes (ROM's) can include a spiral wound membrane, a plate and frame membrane, and a tubular membrane. The RO membrane can have a diameter of from 3.8 to 8 inches, for example, of 3.8 inches, 5.7 inches, 6.3 inches, 7.9 inches, or 8 inches. The RO membrane can have a sodium exclusion of about 98.2 to 99.5.

As used herein, the term “recirculating reverse osmosis” refers to a system where liquid feed enters two or more RO membranes (each housed in a separate pressure vessel) where part of the liquid passes through the membrane (permeate) where another part does not (concentrate). The permeate moves through an outlet while the concentrate or a part of the concentrate recirculates through one or more RO membranes then exits through a separate outlet. The RRO process retains all of the solids and minerals present in the starting material, and eliminates primarily water. Flow rate through the RRO system decreases as the concentration increases.

In the presently described process, the concentrate is not blended back with incoming feed stock.

The presently described system can include, with regard to the entire RRO system or a single stage of a multi-stage RRO system, from 2 to 50 RO membrane elements, from 5 to 45, from 10 to 40, from 15 to 40, from 20 to 40, from 25 to 37, from 25 to 35, from 27 to 35, from 30 to 34, from 31 to 33, 30, 31, 32, 33, 34, 35, 2 to 30, from 2 to 25, from 2 to 20, from 2 to 15, from 2 to 10, or from 3 to 8, RO membrane elements. The permeate, for example, water, can be recovered and used, for example, to clean the RRO system.

The presently described RRO system can include or consist of a multi-stage RRO system having from 2 to 20 stages, from 2 to 18 stages, from 2 to 16 stages, from 2 to 14 stages, from 2 to 12 stages, from 2 to 10 stages, from 2 to 8 stages, from 2 to 6 stages, from 2 to 4 stages, from 3 to 20 stages, from 3 to 18 stages, from 3 to 16 stages, from 3 to 14 stages, from 3 to 12 stages, from 3 to 10 stages, from 3 to 8 stages, from 3 to 6 stages, from 3 to 4 stages, from 4 to 20 stages, from 4 to 18 stages, from 4 to 16 stages, from 4 to 14 stages, from 4 to 12 stages, from 4 to 10 stages, from 4 to 8 stages, from 4 to 6 stages, from 5 to 20 stages, from 5 to 18 stages, from 5 to 16 stages, from 5 to 14 stages, from 5 to 12 stages, from 5 to 10 stages, from 5 to 8 stages, from 5 to 6 stages, from 6 to 20 stages, from 6 to 18 stages, from 6 to 16 stages, from 6 to 14 stages, from 6 to 12 stages, from 6 to 10 stages, from 6 to 8 stages, from 7 to 20 stages, from 7 to 18 stages, from 7 to 16 stages, from 7 to 14 stages, from 7 to 12 stages, from 7 to 10 stages, from 7 to 8 stages, from 8 to 20 stages, from 8 to 18 stages, from 8 to 16 stages, from 8 to 14 stages, from 8 to 12 stages, from 8 to 10 stages, from 9 to 20 stages, from 9 to 18 stages, from 9 to 16 stages, from 9 to 14 stages, from 9 to 12 stages, from 9 to 10 stages, from 10 to 20 stages, from 10 to 18 stages, from 10 to 16 stages, from 10 to 14 stages, from 10 to 12 stages, from 11 to 20 stages, from 11 to 18 stages, from 11 to 16 stages, from 11 to 14 stages, from 11 to 12 stages, from 12 to 20 stages, from 12 to 18 stages, from 12 to 16 stages, from 12 to 14 stages, from 13 to 20 stages, from 13 to 18 stages, from 13 to 16 stages, from 13 to 14 stages, from 14 to 20 stages, from 14 to 18 stages, from 14 to 16 stages, from 15 to 18 stages, from 15 to 16 stages, from 16 to 20 stages, from 16 to 18 stages, from 17 to 18 stages, from 3 to 10 stages, from 4 to 8 stages, 4 stages, 5 stages, 6 stages, 7 stages, or 8 stages. The present RRO system can have from 3 to 12 stages. Each stage of the present RRO system can have from 3 to 10 pressure vessels, from 4 to 9 pressure vessels, from 5 to 8 pressure vessels, 5 pressure vessels, 6 pressure vessels, 7 pressure vessels, or 8 pressure vessels, each housing from 1 to 10 RO membranes, from 2 to 9 RO membranes, from 3 to 8 RO membranes, from 4 to 7 RO membranes, from 5 to 6 RO membranes, or 5 RO membranes.

In a one stage RO system, the feedstock enters the RO system as one stream and exits the RO as two streams, one stream is the concentrate and the other is permeate water.

In a two-stage RO system the concentrate from the first stage becomes the feedstock to the second stage. A small portion of the feed continues down the baseline of the system and becomes the feed to the second stage. The remaining feed material travels back up the baseline to be recirculated back into the first stage. The second stage then concentrates the feed stock from stage one and a smaller portion is bled out of the back pressure valve as the finished product. The feed from stage one that does not exit the system gets recirculated up the baseline back into stage two. Additional stages increase the recovery from the system. In an RO an array describes the physical arrangement of the pressure vessels, for example, in a multi-stage system. Pressure vessels contain RO membranes (for example, each pressure vessel can contain from 1 to 12 RO membranes, from 1 to 10, from 1 to 8, from 1 to 6, from 1 to 5, from 1 to 4, from 1 to 3, 1, 2, 3, 4, 5, 6, 7, 8, 9, 10, 11, 12, from 2 to 12, from 2 to 10, from 2 to 8, from 2 to 6, from 2 to 5, from 2 to 4, from 3 to 12, from 3 to 10, from 3 to 8, from 3 to 6, from 3 to 5, from 3 to 4, from 4 to 12, from 4 to 10, from 4 to 8, from 4 to 6, from 4 to 5, from 5 to 12, from 5 to 10, from 5 to 8, from 5 to 6, from 6 to 12, from 6 to 10, from 6 to 8, from 7 to 12, from 7 to 10, from 7 to 8, from 8 to 12, from 8 to 10, from 9 to 12, from 9 to 10, or from 10 to 12 RO membranes. Each stage can have a certain number of pressure vessels with RO membranes. The concentrate of each stage then becomes the feed stock for the next successive stage. In a, for example, an RO system that is a 2:1 array, the concentrate of the first 2 RO vessels is fed to the next 1 vessel. An array system and a staged system are two different types of systems.

In the presently described RRO system, a concentrate recycle setup is utilized where a portion of the concentrate stream is fed to the second stage of the RRO system to increase the concentration and system recovery. A single pass system is a system that does not allow concentrate from the stage to be recycled back into that stage again. Only a staged system allows concentrate to be recycled back to the stage that it just came from.

As used herein, the term “serum protein” refers to the protein content of milk plasma other than casein (i.e., serum protein refers to whey protein content).

As used herein, the term “shelf-life” refers to the period of time at which a dairy product can be stored at 70° F. without developing an objectionable organoleptic characteristic, such as an objectionable aroma, appearance, taste, consistency, or mouthfeel. In addition, an organoleptically acceptable dairy product at a given shelf life will have no off-odor, off-flavor, or brown coloring, will not have a clumped, ropy, or slippery texture, and will remain ungelled. “Stable” or “shelf-stable” means that the dairy product at a given time does not have objectionable organoleptic characteristics as defined above and is organoleptically acceptable.

As used herein, the term “starting material” refers to any milk or liquid milk product as presently described, that is used as the starting material in the presently described process. The starting material can include but is not limited to, for example, skim milk, low fat milk, or whole milk. The term “starting material” can mean the material entering the RRO system, or the material entering a separation step, including for example, a cold-bowl separation step. The term “feed stock” as used herein, refers to the material entering the RRO system after any previous separation or treatment step.

The presently described concentrated milk product can comprise from about 25 wt % to about 40 wt % solids-not-fat (SNF), from about 26 wt % to about 38 wt % SNF, from about 26 wt % to about 36 wt % SNF, from about 26 wt % to about 34 wt % SNF, from about 26 wt % to about 33 wt % SNF, from about 26 wt % to about 32 wt % SNF, from about 26 wt % to about 31 wt % SNF, from about 26 wt % to about 30 wt % SNF, from about 26 wt % to about 29 wt % SNF, from about 27 wt % to about 38 wt % SNF, from about 27 wt % to about 36 wt % SNF, from about 27 wt % to about 34 wt % SNF, from about 27 wt % to about 33 wt % SNF, from about 27 wt % to about 32 wt % SNF, from about 27 wt % to about 31 wt % SNF, from about 27 wt % to about 30 wt % SNF, from about 27 wt % to about 29 wt % SNF, from about 28 wt % to about 38 wt % SNF, from about 28 wt % to about 36 wt % SNF, from about 28 wt % to about 34 wt % SNF, from about 28 wt % to about 33 wt % SNF, from about 28 wt % to about 32 wt % SNF, from about 28 wt % to about 31 wt % SNF, from about 28 wt % to about 30 wt % SNF, from about 28 wt % to about 29 wt % SNF, from about 29 wt % to about 38 wt % SNF, from about 29 wt % to about 36 wt % SNF, from about 29 wt % to about 34 wt % SNF, from about 29 wt % to about 33 wt % SNF, from about 29 wt % to about 32 wt % SNF, from about 29 wt % to about 31 wt % SNF, from about 29 wt % to about 30 wt % SNF, from about 30 wt % to about 38 wt % SNF, from about 30 wt % to about 36 wt % SNF, from about 30 wt % to about 34 wt % SNF, from about 30 wt % to about 33 wt % SNF, from about 30 wt % to about 32 wt % SNF, from about 30 wt % to about 31 wt % SNF, about 25 wt % SNF, about 26 wt % SNF, about 27 wt % SNF, about 28 wt % SNF, about 29 wt % SNF, about 30 wt % SNF, about 31 wt % SNF, about 32 wt % SNF, about 33 wt % SNF, about 34 wt % SNF, about 35 wt %, or about 36 wt % SNF.

As used herein, the term “total milk solids” or “total solids” (TS) refers to the total of the fat and solid-not-fat (SNF) contents. “SNF” refers to the total weight of the protein, lactose, minerals, acids, enzymes, and vitamins, and does not include fat solids.

When the milk product or feed stock entering the RRO system, is skim milk or nonfat milk, the SNF wt % will substantially equal the total solids wt %.

When the milk product entering the reverse osmosis system, i.e., the feed stock, is a milk product containing fat, including but not limited to, for example, low fat milk or full fat milk, the presently described concentrated milk product can comprise from about 34 wt % to about 45 wt % total solids, from about 34 wt % to about 44 wt % total solids, from about 34 wt % to about 42 wt % total solids, from about 34 wt % to about 40 wt % total solids, from about 34 wt % to about 38 wt % total solids, from about 34 wt % to about 36 wt % total solids, from about 35 wt % to about 44 wt % total solids, from about 35 wt % to about 42 wt % total solids, from about 35 wt % to about 40 wt % total solids, from about 35 wt % to about 40 wt % total solids, from about 35 wt % to about 38 wt % total solids, from about 35 wt % to about 36 wt % total solids, from about 36 wt % to about 44 wt % total solids, from about 36 wt % to about 42 wt % total solids, from about 36 wt % to about 40 wt % total solids, from about 36 wt % to about 38 wt % total solids, from about 38 wt % to about 44 wt % total solids, from about 38 wt % to about 42 wt % total solids, from about 38 wt % to about 40 wt % total solids, from about 40 wt % to about 44 wt % total solids, from about 40 wt % to about 42 wt % total solids, from about 42 wt % to about 44 wt % total solids, about 34 wt % total solids, about 35 wt % total solids, about 36 wt % total solids, about 37 wt % total solids, about 38 wt % total solids, about 39 wt % total solids, about 40 wt % total solids, about 41 wt % total solids, about 42 wt % total solids, about 43 wt % total solids, about 44 wt % total solids, or about 45 wt % total solids.

Any concentration ranges, percentage range, or ratio range recited herein are to be understood as expressly disclosing and including any concentrations, percentages or ratios of any integer within that range and fractions thereof, such as one tenth and one hundredth of an integer, and any sub-range falling within a range, unless otherwise indicated.

Any number range recited herein relating to any parameter, including for example, temperature, concentration, amounts, pore size, numbers, size, or thickness, are to be understood as expressly disclosing and including any integer or fraction of an integer within a disclosed range, or any sub-range within a disclosed range, unless otherwise indicated.

It should be understood that the terms “a” and “an” as used above and elsewhere herein refer to “one or more” of the enumerated components. It will be clear to one of ordinary skill in the art that the use of the singular includes the plural unless specifically stated otherwise. Therefore, the terms “a,” “an” and “at least one” are used interchangeably in this application.

For the purpose of clarity, any element or feature of any method or composition or process described herein, can be combined with any other element or feature of any other method or composition or process described herein.

Throughout the application, descriptions of various embodiments use “comprising” language; however, it will be understood by one of skill in the art, that in some specific instances, an embodiment can alternatively be described using the language “consisting essentially of” or “consisting of.”

Other terms as used herein are meant to be defined by their well-known meanings in the art.

The milk or milk products produced or starting materials used in the present processes can be standardized or non-standardized. Standardization of milk refers to the adjustment, i.e., raising or lowering of fat and SNF levels of milk. The standardization of milk is commonly done in the marketed milk supply and also in the manufacture of milk products, e.g. condensed milk, milk powder, ice-cream and cheese, etc. Standardization can be done in order to provide a uniform milk fat content in a finished dairy product, or in a starting material. Standardization can be performed by known methods in the art to which the presently described subject matter applies.

The presently described subject matter can include a RRO process for the concentration of a composition, e.g., including but not limited to raw milk, whole milk, skim milk, low-fat milk, standardized milk, or other milk containing composition or product, including carrying out at least one process step, at least a portion of the process, or the entire process, where the milk feedstock entering the RRO system enters the system at a temperature at or below 45° F.

The presently described subject matter can include a RRO process for the concentration of a composition, e.g., including but not limited to raw milk, whole milk, skim milk, low-fat milk, standardized milk, or other milk containing composition or product, including carrying out at least one process step, at least a portion of the process, or the entire process, provided that the feedstock may be at a temperature at or below 45° F., for example, from 29° F. to 45° F., from 30° F. to 43° F. from 32° F. to 43° F., from 35° F. to 43° F., from 37° F. to 41° F. from 39° F. to 40° F., 35° F., 36° F., 37° F., 38° F., 39° F., 40° F., 41° F., 42° F., 43° F., 44° F., or 45° F., when entering the RRO system, at a temperature from 29° F. to 45° F., above 45° F. to 60° F., from 46° F. to 60° F., from 47° F. to 60° F., from 48° F. to 60° F., from 49° F. to 60° F., from 50° F. to 60° F., from 51° F. to 60° F., from 52° F. to 60° F., from 53° F. to 60° F., from 54° F. to 60° F., from 55° F. to 60° F., from 56° F. to 60° F., from 57° F. to 60° F., from 58° F. to 60° F., or from 59° F. to 60° F.

The presently described subject matter can include a RRO process for the concentration of a composition, e.g., including but not limited to raw milk, whole milk, skim milk, low-fat milk, standardized milk, or other milk containing composition or product, where at a particular time point or for a particular period of time during the process or during the entire process, provided that the feedstock may be at a temperature at or below 45° F., for example, from 29° F. to 45° F., from 30° F. to 43° F., from 32° F. to 43° F., from 35° F. to 43° F., from 37° F. to 41° F. from 39° F. to 40° F., 35° F., 36° F., 37° F., 38° F., 39° F., 40° F., 41° F., 42° F., 43° F., 44° F., or 45° F., when entering the RRO system, the process a maximum temperature is achieved, where the maximum temperature is >46° F. and ≦60° F., >47° F. and ≦60° F., >48° F. and ≦60° F., >49° F. and ≦60° F., >50° F. and ≦60° F., >51° F. and ≦60° F., >52° F. and ≦60° F., >53° F. and ≦60° F., >54° F. and ≦70° F., >55° F. and ≦70° F., >56° F. and ≦70° F., >57° F. and ≦70° F., >58° F. and ≦60° F., >59° F. and ≦60° F., 46° F., 47° F., 48° F., 49° F., 50° F., 51° F., 52° F., 53° F., 54° F., 55° F., 56° F., 57° F., 58° F., 59° F., or 60° F.

Accordingly to the presently described subject matter, the maximum RRO concentration process temperature is not 45° F. or below, is not 46° F. or below, is not 47° F. or below, is not 48° F. or below, is not 49° F. or below, or is not 50° F. or below.

The presently described subject matter can include a RRO process for the concentration of a milk composition, e.g., including but not limited to raw milk, whole milk, skim milk, low-fat milk, standardized milk, or other milk containing composition or product, where the initial temperature of the feed composition prior to entering the RRO system, is at an initial temperature of from 30° F. to 50° F., 32° F. to 48° F., 34° F. to 46° F., 36° F. to 44° F., 38° F. to 42° F., 39° F. to 41° F., 30° F. to 49° F., 30° F. to 48° F., 30° F. to 47° F., 30° F. to 46° F., 30° F. to 45° F., 30° F. to 44° F., 30° F. to 43° F., 30° F. to 42° F., 30° F. to 41° F., 30° F. to 40° F., 30° F. to 39° F., 30° F. to 38° F., 30° F. to 37° F., 30° F. to 36° F., 30° F. to 34° F., 30° F. to 32° F., 32° F. to 50° F., 32° F. to 48° F., 32° F. to 46° F., 32° F. to 44° F., 32° F. to 42° F., 32° F. to 40° F., 32° F. to 38° F., 32° F. to 36° F., 32° F. to 34° F., 34° F. to 50° F., 34° F. to 48° F., 34° F. to 46° F., 34° F. to 44° F., 34° F. to 42° F., 34° F. to 40° F., 34° F. to 38° F., 34° F. to 36° F., 36° F. to 50° F., 36° F. to 48° F., 36° F. to 46° F., 36° F. to 44° F., 36° F. to 42° F., 36° F. to 40° F., 36° F. to 38° F., 38° F. to 50° F., 38° F. to 48° F., 38° F. to 46° F., 38° F. to 44° F., 38° F. to 42° F., 38° F. to 40° F., 40° F. to 50° F., 40° F. to 48° F., 40° F. to 46° F., 40° F. to 44° F., 40° F. to 42° F., 30° F., 31° F., 32° F., 33° F., 34° F., 35° F., 36° F., 37° F., 38° F., 39° F., 40° F., 41° F., 42° F., 43° F., 44° F., 45° F., 46° F., 47° F., 48° F., 49° F., or 50° F.

Use of a RRO concentration process or process step or steps can be coupled with the selection of one or more heat-treatment temperatures. In combining these two parameters, microbiological activity in the treated product when it is stored in sealed containers at, for example, 10° C. to 40° C., or 10° C. to 30° C., for extended periods, can be inhibited. Additionally, the use of a the presently described concentration process coupled with a sterilization step, produces a product that has a flavor that is acceptable to the consumer.

The presently described subject matter is further directed to a process for concentrating or partially concentrating a composition, e.g., including but not limited to raw milk, whole milk, skim milk, low-fat milk, standardized milk, or other milk containing composition or product, where the concentrating or partially concentrating, after the feed stock enters the RRO system, is not carried out temperature of 45° F. or below, 46° F. or below, 47° F. or below, 48° F. or below, 49° F. or below, or 50° F. or below.

The presently described subject matter provides a process a composition, e.g., including but not limited to raw milk, whole milk, skim milk, low-fat milk, standardized milk, or other milk containing composition or product, that create an aseptic product that has suffered no structural damage. The presently described subject matter is further directed to a process that produces a milk product that is consumer acceptable and can substantially retain natural milk flavor and taste.

The presently described subject matter achieves a product that can retain the taste and flavor of natural milk. During reverse osmosis, anti-microbial substances of raw milk such as peroxidase, become concentrated. The natural anti-microbial substances of raw milk are very effective against bacteria and their spores. In traditional condensed milk, the pre-heat treatment before concentration and subsequent heat concentration destroys natural antimicrobial substances of milk; therefore, bacterial spores increase. Therefore, traditional condensed milks generally spoil faster than RO-concentrated milks.

Accordingly, provided is a process for the production of a liquid milk product that is substantially free from micro-organisms that would bring about spoilage during storage of an untreated product at temperatures higher than the ranges provided by refrigeration.

The presently described subject matter is directed to a process for producing a sterilized, concentrated milk product comprising the steps of concentrating, for example, partially concentrating, milk or a milk product at temperatures according to the presently described subject matter. The sterilization process can comprise heating the concentrated or partially concentrated milk product through one or more high temperature treatments. The sterilization process can comprise heating the concentrated or partially concentrated milk product to a first elevated temperature. The concentrated or partially concentrated milk product that is heated at the first elevated temperature can be further heated to a second elevated temperature.

The presently described process can be used for sterilizing any milk or liquid milk product. The milk product as described herein, including, but not limited to, raw milk, whole milk, skim milk, low-fat milk, standardized milk, or other milk containing composition or product, including a concentrated milk product.

The presently described subject matter is directed to a method for producing a liquid milk product that can comprise concentrating a starting material containing for example, approximately 3 wt % milk fat and for example, approximately 9 wt % solids-not-fat (SNF). The starting material can comprise about 3 wt % milk fat, 3.25 wt % milk fat, from 1 wt % milk fat to 3.5 wt %, from 1.5 wt % milk fat to 3.5 wt %, from 2 wt % milk fat to 3.5 wt %, from 2.5 wt % milk fat to 3.5 wt %, from 3 wt % milk fat to 3.5 wt %, from 1 wt % milk fat to 3.25 wt %, from 1.5 wt % milk fat to 3.25 wt %, from 2 wt % milk fat to 3.25 wt %, from 2.5 wt % milk fat to 3.25 wt %, from 3 wt % milk fat to 3.25 wt %, from 0.05 wt % milk fat to 2 wt %, from 0.05 wt % milk fat to 1 wt %, from 0.05 wt % milk fat to 0.5 wt %, from 0.1 wt % milk fat to 0.2 wt %, from 0.1 wt % milk fat to 0.3 wt %, 0.1 wt % to 0.4 wt %, not more than 0.5 wt % milk fat, not more than 0.4 wt % milk fat, not more than 0.3 wt % milk fat, not more than 0.2 wt % milk fat, or not more than 0.1 wt % milk fat.

The starting material can be subjected to a separation step, for example, using a cold bowl separation step at 45° F. or less, for example, from 37° F. to 45° F., from 38° F. to 44° F., from 38° F. to 43° F., from 38° F. to 42° F., from 38° F. to 41° F., from 39° F. to 44° F., from 39° F. to 43° F., from 39° F. to 42° F., from 38° F. to 41° F., 37° F., 38° F., 39° F., 40° F., 41° F., 42° F., 43° F., 44° F., or 45° F. For example, the cream can be separated from the remainder of the milk to produce a skim milk product. The cold bowl separation method can comprise centrifugal separation of milk fat from the SNF. Alternatively, the separation, for example, cold bowl separation, can be carried out at a temperature of not more than 70° F., not more than 65° F., not more than 60° F., from 37° F. to 70° F., from 40° F. to 65° F., from 42° F. to 62° F., from 42° F. to 55° F., from 43° F. to 54° F., from 43° F. to 53° F., from 44° F. to 52° F., from 45° F. to 51° F., from 46° F. to 50° F., 44° F., 45° F., 46° F., 47° F., 48° F., 49° F., 50° F., 51° F., or 52° F.

Skim milk that is produced by methods including, but not limited to, the cold bowl separation process can be concentrated for a sufficient length of time to remove water and form an intermediate liquid concentrated milk product as presently described.

The presently described subject matter is directed to a concentration process that removes water from the starting material. For example, the concentration process can remove, for example, at least 50%, at least 55%, at least 60%, at least 65%, or at least 70%, of the water from the starting material. For example, the volume of the starting material can be decreased by at least 50%, by at least 55%, by at least 60%, by at least 65%, or by at least 70%, after the concentration step.

The presently described concentration process can be performed by reverse osmosis, including for example, recirculating reverse osmosis. Suitable RO membranes can have a sodium exclusion of 98.2 to 99.5.

The presently described RRO process can be performed at pressures, throughout the entire process, at the onset of the process, or at or near completion of the RRO process, of from about 200 psi to about 1500 psi, of from about 200 psi to about 1000 psi, of from about 250 psi to about 750 psi, of from about 250 psi to about 550 psi, of from about 250 psi to about 500 psi, of from about 300 psi to about 500 psi, of from about 300 psi to about 600 psi, of from about 350 psi to about 550 psi, of from about 250 psi to about 450 psi, of from about 350 psi to about 450 psi, of from about 350 psi to about 475 psi, of from about 300 psi to about 450 psi, of from about 300 psi to about 400 psi, of from about 250 psi to about 400 psi, of from about 250 psi to about 350 psi, about 200 psi, about 225 psi, about 250 psi, about 275 psi, about 300 psi, about 325 psi, about 350 psi, about 375 psi, about 400 psi, about 425 psi, about 450 psi, about 475 psi, about 500 psi, about 525 psi, about 550 psi, about 575 psi, about 600 psi, about 625 psi, or about 650 psi. A suitable running pressure for concentrating fresh skim milk is of from about 400 psi to about 450 psi, or about 425 psi. A suitable running pressure for concentrating fresh milk products can be of from about 350 psi to about 475 psi. At the beginning of the RRO process, an initial pressure range can increase as concentration progresses by about 25 psi to about 200 psi, of from about 50 psi to about 175 psi, of from about 75 psi to about 150 psi, of from about 100 psi to about 125 psi, about 50 psi, about 75 psi, about 100 psi, about 125 psi, or about 150 psi. Each of the ranges described above with regard to running pressure, can be modified by the foregoing increased pressure ranges. For example, if an initial running pressure is from about 350 psi to 475 psi, the running pressure toward or at completion of concentration, can be from 450 psi to 575 psi.

The presently described process for concentrating a milk product can be performed without adjusting pH during the process. The presently described RRO process can be performed without adjusting pH.

The RRO process retains all of the solids and minerals present in the starting material, and eliminates primarily water.

The presently described subject matter is also directed to a process where an amount of unpasteurized cream (for example, the cream removed from the starting material in the separation step) is mixed with an intermediate milk concentrate to form a liquid blend having a predetermined range of fat content.

The presently described subject matter is further directed to a liquid milk concentrate that is produced by mixing a sufficient amount of a stabilizer material with a predetermined amount of an intermediate milk concentrate. The stabilizer material can ensure the uniform distribution of milk solids and inhibits separation and settling of milk solids in the liquid milk concentrate during storage, either before or after sterilization. The stabilizer material can assist in the production of a protein complex for forming a stable dispersion of colloidal constituents and to substantially uniformly distribute the colloidal constituents in the liquid milk concentrate.

The stabilizer material can maintain the pH of the liquid milk concentrate in the range of about 5.5 to about 6.8, e.g., at the same pH range as the starting material, during the sterilization step. The stabilizer material is further effective for inhibiting thermal coagulation of milk proteins during or after sterilization. Additionally, the stabilizer material can inhibit the coagulation of proteins at the pH range of the milk concentrate. The SNF content in the liquid milk concentrate is as presently described, for example, including but not limited to, of at least 25 wt %, at least 26 wt %, at least 27 wt %, at least 28 wt %, at least 29 wt % or at least 30 wt % of the concentrate. Such a liquid milk concentrate can be reconstituted with water or any other suitable diluent to produce a reconstituted milk beverage having a SNF content of, for example, about 8% by weight, which is comparable to raw milk.

Suitable stabilizing materials can include, but are not limited to, one or more of carrageenan or phosphate salts, including but not limited to, hexametaphosphate, including for example, sodium hexametaphosphate.

The liquid milk concentrate can be subjected to a regimen of elevated temperatures to form the sterilized liquid milk concentrate. The liquid milk concentrate can be sterilized and/or homogenized to form a final liquid milk product that can then be packaged. The sterilized liquid milk concentrate can be mixed with a suitable quantity of water to form a beverage having the consistency and taste of milk. The sterilized liquid milk concentrate can be mixed with a diluent other than water to form a desired reconstituted milk beverage.

The presently described subject matter is directed to a sterilization process, including a heating step that includes initially heating a liquid milk concentrate to a first elevated temperature for a defined time period to produce a first heated concentrate.

The presently described subject matter is directed to a sterilization process, where the first heated concentrate is heated to a second elevated temperature that can be higher than the first elevated temperature. Heating the first heated concentrate to a second elevated temperature for a defined period of time produces a sterilized liquid milk concentrate.

The presently described subject matter is directed to process that can be conducted in a continuous manner. In the continuous process, the starting material flows from a storage facility, through a concentration process, including for example, RRO using for example, from 2 to 35 RO membranes, followed by a sterilization step. The sterilized product can be packaged for distribution. During at least a time point during the process or for a period of time during the process or at a particular process step, the composition being concentrated reaches a maximum temperature as presently described, for example, of greater than 45° F. to 60° F.

The presently described subject matter is directed to a process that does not include sterilization. In such a process after concentrating, the concentrated product is transported to a separate site and stored for future sterilization. When the need arises, the concentrated product is recovered from storage and sterilized. For example, the concentrated product can be stored in a holding tank and maintained at a temperature of 38° F. or less.

The presently described subject matter is directed to an RRO concentration process that does not include one or more of ultrafiltration and nanofiltration.

The presently described subject matter can be made virtually bacteria-, bacterial spore- and somatic cell-free by microfiltration before reverse osmosis, which can help in performing sterilization or UHT treatment at the minimum legal requirements to get a better shelf life and taste.

The presently described subject matter is directed to an RRO concentration process that may or may not include pretreating the starting material or composition. Such pretreatment can include prefiltering and/or preheating. The presently described subject matter is directed to a process that does not include sterilization. In such a process, the starting material can be concentrated by removing water, as presently described. In such a process, prior to sterilization, the concentrated milk product can be diluted and the fat content can be adjusted.

When concentrating and sterilizing are conducted separately as described above, i.e., not in a continuous manner, concentrating can be carried out to achieve a higher concentration (as presently described herein) of, for example, SNF and/or milk fat, than that achieved using a continuous process. Further, concentrating can be followed by an adjustment of the total solids and/or milk fat content of the concentrated milk product before it is sterilized. Thus, for instance, cream or butter oil may be added to increase the milk fat content and, especially when the concentrating step has provided a greater degree of concentration, the milk product may be diluted to reduce the total solids content. Bifurcating the concentration and sterilization steps is particularly convenient where concentrated skimmed milk is transported to a site for sterilization and it is desired to produce a product having the character of concentrated sterilized whole milk. In this case, the concentrated skimmed milk product would be supplemented with total solids and/or milk fat content in an amount that matches the profile of whole milk, prior to the sterilization step.

The concentrating step can include a reduction in volume of the initial starting material as presently described.

The presently described subject matter is directed to a process and product where the concentrated or partially concentrated milk product contains a concentration of SNF as presently described, for example, of at least about 25 wt % SNF, at least 26 wt %, at least 27 wt %, at least 28 wt %, at least 29 wt %, at least 30 wt %, at least 31 wt %, at least 32 wt %, at least 33 wt %, at least 34 wt %, at least 35 wt %, at least 36 wt %, at least 37 wt %, at least 38 wt %, at least 39 wt %, or at least 40 wt % of the concentrate.

The presently described subject matter is directed to a process where concentrating is carried using a RRO system where either raw milk or skimmed milk (in which milk fat has been removed from the raw milk) is passed through a series of pumps and membranes that use osmotic pressure to remove water from the starting material. The temperature during at least a part of the RRO process is as presently described, for example, is above 45° F. to 60° F., and pressures are typically maintained as presently described, for example, at from 300 psi to 475 psi, or from 300 psi to less than 450 psi. The concentration levels that can be achieved using RRO system can be from about 2.5-fold to 4-fold, from 3-fold to 4-fold, about 3-fold, about 3.8-fold, about 4-fold, about 4.1-fold, or about 4.5-fold.

In a process as presently described, the pH of an intermediate milk concentrate prepared by the RRO process where at least a part of the process is carried out at a temperature from above 45° F. to 60° F. can be unaffected by the concentration process.

The presently described subject matter is directed to a process where after concentrating or sterilizing, the pH of the concentrated or concentrated and sterilized product, can optionally be adjusted a pH, for example, of from 6.2 to 6.8, by raising or lowering the pH.

The presently described subject matter is directed to process where following concentrating, various concentrated products can be made including without limitation, including, but not limited to, non-fat, reduced fat, low fat, whole, chocolate, coffee, and lactose-reduced variants. All of the products can be batched as a raw mixture of cream and concentrated whole or skim concentrated milks. One or more additional processing aids and/or flavors may be added concentrated products.

Following concentration, either immediately or after storage, sterilization may be achieved by any conventional sterilization method, for instance, by heating the partially concentrated milk product in bulk, or preferably, in a continuous flow process where the milk product is passed over one or more conventional heat exchangers, such as conventional indirect plate, coiled tube or scraped surface heat exchangers or by ohmic heating. Heating rates and holding times may be selected as convenient depending on the equipment in use. For example, an aseptic processing module for direct UHT treatment of liquid food products with direct steam injection can be used.

The presently described subject matter is directed to sterilization process comprising heating the concentrated milk product to a high temperature in one or more stages. The milk product can be subjected to a first heating step or “pre-heating” treatment at an elevated first temperature for a predetermined period of time to produce a first heated or pre-heated concentrate. The pre-heated product can then heated to an elevated second temperature that is higher than the pre-heating temperature to produce a sterilized or second heated concentrate. An example of a multi-stage heating regime can comprise a two-step heating process in which the first step takes the temperature of the concentrated product from its holding temperature of 40° F.-45° F. to 175° F.-185° F. (and in some cases to 210° F.), from its holding temperature of 40° F.-60° F. to 175° F.-185° F. (and in some cases to 210° F.), from its holding temperature of greater than 45° F.-60° F. to 175° F.-185° F. (and in some cases to 210° F.), from its holding temperature of 50° F.-60° F. to 175° F.-185° F. (and in some cases to 210° F.), from its holding temperature of 52° F.-60° F. to 175° F.-185° F. (and in some cases to 210° F.), from its holding temperature of 54° F.-60° F. to 175° F.-185° F. (and in some cases to 210° F.), from its holding temperature of 56° F.-60° F. to 175° F.-185° F. (and in some cases to 210° F.), from its holding temperature of 58° F.-60° F. to 175° F.-185° F. (and in some cases to 210° F.), from its holding temperature of 46° F. to 175° F.-185° F. (and in some cases to 210° F.), from its holding temperature of 48° F. to 175° F. to 185° F. (and in some cases to 210° F.), from its holding temperature of 50° F. to 175° F.-185° F., from its holding temperature of 55° F. to 175° F.-185° F. (and in some cases to 210° F.), or from its holding temperature of 60° F. to 175° F.-185° F. (and in some cases to 210° F.). The temperature of the concentrate after RRO can be dropped back to 40° F. to 45° F. where sterilization does not directly follow RRO concentration and the concentrate is stored in a silo prior to sterilization. The transition from the holding temperature to the first elevated temperature is completed in 45 seconds or less. The short transition time achieves a product that does not have a “burnt” flavor and whose structural integrity is maintained. The transition time to heat the concentrated milk product to a first elevated temperature is as short as possible, for example, the transition time can be 45 seconds or less, or 45 seconds. The presently described subject matter is directed to sterilization process further comprising upon reaching a first elevated temperature of 175° F.-185° F. (and in some cases to 210° F.), the first heated concentrate is transitioned to a second elevated temperature of from 283° F. to about 300° F., or from 283° F. to 295° F. in 6 seconds or less. The transition time to heat the first heated concentrated to a second elevated temperature can be at least 5 seconds. The second heated concentrate can be held at the second elevated temperature for a period of from 2 to 6 seconds. The hold period at the second elevated temperature is regulated by the FDA as a minimum length of time required to confer product sterility. The final heating can be achieved by indirect heating in plate heat exchangers or shell and tube type of heat exchangers.

The presently described subject matter is directed to sterilization process, where a liquid milk product concentrated by RRO is heat-treated. The liquid milk product concentrated by RRO, may optionally be brought down to a temperature below 45° F. and stored until a sterilization process is commenced. The concentrated milk product can be subjected to a first heat treatment step (“pre-heat step”) in a heat exchanger. Instantaneous heating to the sterilization temperature takes place in the steam injector by continuous injection of high pressure steam into the product. In the pre-heat step, the concentrated milk product is heated from a temperature at which the concentration process is carried out at, e.g., from greater than 45° F.-60° F. to 175° F.-185° F. (and in some cases to 210° F.), from a temperature of 40° F.-45° F. to 175° F.-185° F. (and in some cases to 210° F.), from a temperature of 40° F.-60° F. to 175° F.-185° F. (and in some cases to 210° F.), from a temperature of greater than 45° F.-60° F. to 175° F.-185° F. (and in some cases to 210° F.), from a temperature of 50° F.-60° F. to 175° F.-185° F. (and in some cases to 210° F.), from a temperature of 52° F.-60° F. to 175° F.-185° F. (and in some cases to 210° F.), from a temperature of 54° F.-60° F. to 175° F.-185° F. (and in some cases to 210° F.), from a temperature of 56° F.-60° F. to 175° F.-185° F. (and in some cases to 210° F.), from a temperature of 58° F.-60° F. to 175° F.-185° F. (and in some cases to 210° F.), from its holding temperature of 46° F. to 175° F.-185° F. (and in some cases to 210° F.), from a temperature of 48° F. to 175° F.-185° F. (and in some cases to 210° F.), from a temperature of 50° F. to 175° F.-185° F. (and in some cases to 210° F.), from a temperature of 55° F. to 175° F.-185° F. (and in some cases to 210° F.), or from a temperature of 60° F. to 175° F.-185° F. (and in some cases to 210° F.). This “pre-heating” or “first heating” step is carried out in about 45 seconds where the concentrated product is brought up to the pre-heat temperature of 175° F.-185° F. or 210° F., to produce a pre-heated concentrate or a first heated concentrate.

Following the pre-heating in the presently described heat-treatment process, the pre-heated or first heated concentrate is transported through a direct steam injection chamber, where the product is heated to higher temperature in a second heat treatment step. In the second heat treatment step, the pre-heated or first heated concentrate is heated at a pressure above the product's boiling point. For example, the pre-heated or first heated concentrate can be heated from 185° F. (and in some cases to 210° F.) to a temperature of 295° F. or above. The transition from 185° F. (and in some cases to 210° F.) to the higher temperature can be carried out in about 6 seconds or 6 seconds. The steam injection heater can employ a system of perforated injection tubes to force steam into the concentrated liquid milk product to provide substantially instantaneous transfer of heat to the liquid.

The concentrated product can be heated by a process of direct steam injection for a period of from 2 to 6 seconds. The concentrated liquid milk product can be held at the second higher temperature of 295° F. or above for 4 seconds, to produce a second heated concentrate.

Following the direct steam injection stage, the second heated concentrate can be transferred to a flash chamber down leg for about 5 to 10 seconds. In the flash chamber down-leg, the temperature and pressure of the second heated concentrate are immediately lowered. For example, the temperature can be lowered to 185° F. (and in some cases to 210° F.). The excess water added as steam can be flashed off by evaporation in the flash chamber down-leg.

The product can be transferred to an aseptic homogenizer after the flash chamber stage. The homogenizer forces the product through tiny openings to break up the fat. This step distributes the fat evenly throughout the milk product and improves the stability of the final milk product. The homogenized product can be transferred to a regeneration chamber where the temperature is maintained at 185° F. (and in some cases to 210° F.). The transition of the milk product from the flash chamber down-leg through the homogenizer and back to the regeneration chamber takes about 25 seconds.

Following the homogenization step, the temperature of the homogenized product can be lowered from 185° F. (and in some cases to 210° F.) to between 76° F. to 80° F. over a period of about 45 seconds. This cooling of the homogenized product may be achieved by any conventional means. For example, cooling the product, including a concentrated, sterilized, and/or homogenized product, can be accomplished using a heat exchanger where the temperature difference between the cooling media, for example, water, and the product is kept high. After the temperature lowering step, the product may optionally be stored in a holding tank in preparation for transportation and subsequent packaging.

Following the cooling step of the heat-treatment process, the product, for example the sterilized and/or homogenized, liquid milk concentrate can be subjected to lactase enzyme treatment. After treatment with lactase, the treated milk concentrate can be stored in a holding tank, from where it is sent directly to an aseptic filler.

The presently described subject matter is further directed to a process, where the heat-treated milk product is packaged as an aseptic product at 76° F. to 80° F. or 80° F. This product has an average extended shelf-life of 120 days at room temperature (25° C.) when left unopened. The unopened aseptic milk product can have a shelf life of up to 6 months. After the package has been opened, the milk product prepared by the presently described methods can remain edible for up to 30 days.

The presently described heat-treated milk product can be packaged at 45° F. This product can be marketed as an extended shelf-life product having a shelf-life of at least 60 days.

The presently described subject matter will now be described by way of examples.

### EXAMPLE 1

A concentrated and heat-treated milk product is produced using a direct steam injection process. The process is effected using a UHT direct steam injection apparatus as used in the dairy industry. For example, one type of such apparatus used for heat treatment is the direct heating plant in which high pressure potable steam is mixed with the liquid milk product by injecting the steam into the liquid milk product. An example of direct steam injection apparatus is the Tetra Pak VTIS direct steam injection system. The water added to the liquid milk product via the steam is removed later in the process by evaporation, usually under reduced pressure, which also cools the product. The direct steam injection apparatus provides a continuous heat treatment process.

Raw whole cow's milk containing 3.2% by weight milk fat and 8.7% w/w total solids is drawn from a storage tank and passed through a separator, where cream is separated out. The resultant skim or non-fat milk product can then be used as the feedstock in the RRO process. In certain cases, whole milk may be used directly as the RRO feedstock in the presently described concentration and sterilization processes, while in others, skim milk may be used as the feedstock in the RRO process as presently described.

Skim milk is passed through a concentration process using RRO, where greater than 50% of the water is removed and the concentration of the total solids (which is substantially the same at SNF since the feedstock is skim milk) is increased to at least at least 28 wt % to 34 wt %. The concentration step is carried out by RRO at a temperature of from 50° F. to 55° F. and at an initial pressure of about 350 psi to 425 psi and a final pressure of about 400 psi to 525 psi. Thereafter, the concentrated milk product can be brought down to a temperature of <45° F., prior to heat treatment.

In the first heat treatment step, the liquid milk concentrate is pumped through a pre-heat stage bringing its temperature to about 185° F. (and in some cases to 210° F.). The milk is passed, at 185° F. (and in some cases to 210° F.), to a direct steam injection chamber where the temperature of the milk is increased rapidly to above 295° F. with a holding time of 2 to 6 seconds.

In the cooling step, the sterilized milk concentrate is sent to a flash chamber down leg for less than 5-10 seconds, where the excess water/steam is flashed off by evaporation. Still under aseptic conditions, the sterilized concentrated milk stream is optionally passed to a homogenizer. In the homogenization step, the fat is distributed evenly throughout the product. Following this step, the homogenized milk product is transferred to a heat exchanger where the temperature is lowered to 76-80° F.

In the packaging step, the homogenized milk stream is directed to an aseptic packaging station where it is filled into sterile containers under sterile conditions at 80° F. and the containers are sealed. In certain cases, the homogenized milk stream is packaged at 45° F.

### EXAMPLE 2

The description set forth below represents an example of processing specifications used in the presently described processes and the products derived therefrom.

The pH of milk at 25° C. is normally in the range of 6.5-6.7, with a mean value of 6.6. Reliable pH measurement is critical for quality control of fresh milk. The lowering of pH that sometimes can occur when carrying out the UHT processes in the prior art leads to the deterioration of the structure of the casein protein, which in turn causes proteins to irreversibly precipitate out of solution. Thus, an ideal specification for pH on raw ranch milk is 6.6 to 6.7, and for the finished raw concentrate is 6.45 to 6.8.

Titratable acidity is used to estimate freshness of milk. Fresh milk has a titratable acidity of 0.12-0.18% expressed as % lactic acid. Developed acidity indicates growth of lactic acid bacteria. Raw milk with any developed acidity would be unsuitable for UHT processing as it would coagulate during heating. Thus, an ideal titratable acidity is less than or equal to 0.14 for the raw milk and less than or equal to 0.36 for the raw concentrate, when the raw milk is concentrated to greater than 2.5-fold and less than or equal to 4.1-fold.

The maximum US FDA allowable bacterial limit for individual farm raw milk is 100,000/mL and 300,000/m/L for commingled raw milk of different farms before pasteurization. Age of the raw starting material affects final pH level and bacteria levels and is thus important to the final product. According to US federal standards, milk can be held up to 72 hours before receipt for processing. However, an ideal specification for the age of raw milk prior to processing is less than or equal to 24 hours, less than or equal to 20 hours, less than or equal to 16 hours, or less than or equal to 12 hours.

Milk secreted by healthy cows is basically sterile. However, bacteria can be introduced into raw milk from a variety of sources, including exterior and interior of the udder, soil, bedding, manure, milking equipment and storage tanks. The total number of bacteria in raw milk is assessed by direct microscopic count or standard plate count. The standard total plate count (SPC) method is the preferred procedure for the measurement of bacterial levels. The standard plate count of raw milk is referenced in the literature as important in UHT processing, but with no specific recommendations on acceptable maximum levels. The US federal allowable standard is <100,000 cfu/mL. An ideal specification for the bacterial count is less than or equal to 7500. Just like bacterial levels, somatic cell levels (SCC) have been found to be a contributor to the creation of off flavors, as well as gelation in UHT studies. Again, there are no defined target ranges specified. Federal US standards allow for a 750,000 somatic cell count. An ideal specification for somatic cell count is less than 150,000. Two types of enzymes have been found to create issues in UHT products. High levels of proteinase (plasmin) will reduce the stability in storage. This is caused by the hydrolysis of the peptide bonds, particularly in β-casein. Plasmin partially survives high temperature treatment. The level of plasmin is higher in late lactation, in older cows and in mastitic milk. Thus, it would be ideal to monitor age and lactation information of the source raw starting material prior to processing.

### EXAMPLE 3

A concentrated, sterilized milk product was produced by the process set forth in Example 1. The aseptic milk product that was sealed in sterile containers at 80° F. was stored at room temperature (25° C.) in an unopened state for a period of 6 months. When the containers were unsealed after 6 months, the product was found to be free of visual defects, had not separated out of solution and did not contain any particulates, and when reconstituted with water, possessed the aroma, taste and texture of fresh milk.

A concentrated, sterilized milk product produced by the process of Example 1 was stored at 45° F. for a period of 60 days. This product was also found to be free of visual defects, and possessed the taste and aroma characteristics of fresh milk.

### EXAMPLE 4

1.5 million pounds of raw milk was processed into a coffee milk base according to the presently described subject matter, using a six-stage RRO system.

The RRO system can process about 68,000 lbs/hr of skim milk with a fat content in the feedstock of approximately 0.1% as a 6 stage system, with approximately 150, 8 inches in diameter, RO membrane elements. There are 5 pressure vessels per stage (each pressure vessel containing 5 RO membrane elements) with the ability to expand up to 8 pressure vessels per stage.

Basic Processing and Packaging Equipment Equipment:

1. Unloading, loading and washing equipment in two intake bays.

2. Three raw milk silos

3. 2—cold bowl milk separators.

4. Raw cream storage silos.

5. Raw skim milk storage silos.

6. Cream HTST pasteurizer

7. Two section RO membrane plant.

8. Concentrated skim milk storage silos.

9. RO permeate water silos, UV light and distribution system.

10. Pasteurized and Raw CIP systems.

11. Four tank batching system.

12. Aseptic pasteurizer.

13. Aseptic filler feed tank.

14. Aseptic bag fillers.

15. Box erectors.

16. Palletizer

17. Shrink wrap system.

1.5 million pounds of raw Holstein whole milk is subjected to a cold bowl separation process to produce 135,000 lbs. cream and 1,365,000 lbs. a skim milk product having a milk fat content of approximately 0.1 wt %.

Separation Process:

Raw milk is fed from the Raw storage silos at a temperature of between 35° F. and 45° F. through a plate heat exchanger which heats the raw milk to between 45° F. and 70° F. to two cold bowl milk separators at a rate of approximately 75,000 pounds per hour. The stream is split and fed to each of the two separators at a rate of approximately 37,500 pounds per hour into each separator. The separators separate the cream from the skim milk and discharge the cream at a rate of approximately 3,375 pounds per hour each for a total of 6,750 and the skim at a rate of 34,125 each for a total of approximately 68,250 pounds per hour. The cream is directed from the separators through a cooling plate heat exchanger where the temperature of the cream is reduced from the separation temperature to a temperature of less than 45° F. and stored in a raw cream silo. The skim milk discharged is routed through another plate heat exchanger where the temperature is reduced to approximately 38° F. and then to raw skim milk storage silos.

The skim milk is then subjected to a 6-stage RRO process, each stage having 5 pressure vessels, each pressure vessel having 5 RO membrane elements contained therein, to produce 426,562 pounds RRO concentrate. Skim milk enters the RRO system through a set of routing valves that directs the skim milk to the feed balance tank of the RRO. The milk is then pumped by the feed pump through a magnetic flow meter to measure and control the feed flow to the RRO. The flow from this pump is then pumped to up to three more pumps capable of generating up to 600 psi in total pressure when all used together. This flow from or through the high pressure pump set is sent to the baseline of the RO system where the skim milk enters into stage one of the unit. At the entrance to the stage one pump the pressure can range from a low of 100 psi to a high of 600 psi. Upon entering the stage one stage pump, the baseline pressure is increased anywhere between 25 psi and 60 psi. This boosted baseline pressure provides the driving force that will allow the milk to flow down the membrane in the membrane vessel. The internal recirculation rate is typically 3 to 10 that of the feed rate to the system. As the milk flows down the membrane in the vessel. Water (permeate) goes through the membrane and subsequent concentration of the milk occurs. The permeate then exists the vessel through the vessel end cap into a collection header and routed out of the system to drain or further processing. The concentrate milk is then routed back to the baseline through a stage cooler to remove any motor heat that did not exit the system with the permeate. When the concentrated milk gets back to the baseline a portion of it continues down the baseline to stage two. The majority of the stage retentate flow travels back word up the baseline and re-enters the stage one pump to make a second pass through the membrane that it just went through. Typically the amount that gets recycled into stage one is equal to the amount of feed less the permeate amount. The same process of boosting the flow from stage one after it enters the second stage takes place. The internal recirculation rate of the second stage may be the same as stage one, but is actually based on the boosted baseline pressure and the number of vessels and diameter of the membrane vessel in each stage. The second stage then feeds the third stage and so on and so on until the retentate from the final stage exits the system through the back pressure valve as the finished product. This flow is measured by another magnetic flow meter which is used to control the back pressure valve and only allow the retentate quantity out of the system that is desired.

The concentrate is then subjected to a blending and batching process, where flavors may optionally be added, to produce 426,562 pounds of blended, concentrated coffee base. Concentrated skim milk, separated cream and water are each directed from their respective storage silos in the quantity required for a specific batch to one of four batch tanks. Flow and mass flow meters are used by the central controls system to measure and control the volume of each ingredient driven by a pre-loaded recipe. Dry ingredients when required are metered into a blending mixer by a volumetric feeder where they are liquefied with water or product and then added to the same batch tank as the other components. This mixture is then circulated through an inline sanitary mixer to blend all ingredients together. This may or may not require inline heating and/or cooling of the mixture. The resulting batch is then transferred to the Aseptic processor feed tank for further processing.

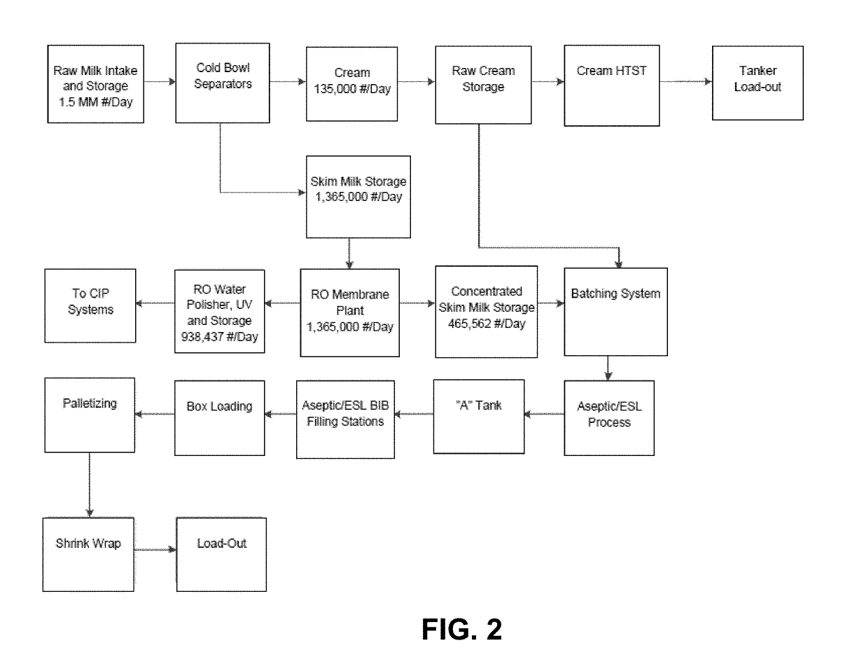

The coffee base is then pasteurized, bagged, cased, and stored. See FIG. 2 and Tables 1-3. The batched product is fed from the Aseptic processor feed tank into a pre-heating section where the temperature of the mix in heated to approximately 176° F. utilizing and indirect heating system. The product then is transferred to the final direct steam heating section where the temperature is raised to approximately 295° F. for 3 to 5 seconds after which the product is immediately transferred to a flash cooler where vapor is drawn off resulting in cooling the product to approximately 179° F. which is then run through a plate heat exchanger cooling section and homogenizing section.

This aseptic product is then sent to a sterile “A” tank which feeds the Aseptic bag filler. The product is routed to the aseptic bag filler where it is volumetrically filled into a sterile bag, of typically 2.5 or 5 gallon volume and the closure inserted then the bag is discharged to either a plastic case or a fiber box that has been erected by a machine from a flat blank and transported via conveyor to the filling machine.

After this the case is closed and sealed or the fiber box is closed and glued or taped shut, sent by conveyor to a check weigh machine, then a palletizer which loads the finished cases or boxes onto a pallet in a pre-programmed pattern. From the palletizer the full pallet is transported by conveyor to a machine that shrink wrappes the entire pallet so it can be unloaded by a fork lift and placed into storage for shipment.

TABLE 1
Mass Balance for 1.5 Million lbs of Raw Holstein Whole Milk

| | Quantity | Fat | | Protein | | Lactose | | Minerals | | SNF | | TS | |
|---|---|---|---|---|---|---|---|---|---|---|---|---|---|
| Ingredient | (lbs) | % | lbs | % | lbs | % | lbs | % | lbs | % | lbs | % | lbs |
| Raw milk | 150000 | 3.7 | 55500 | 3.0 | 45150 | 4.9 | 73500 | 0.7 | 10500 | 8.61 | 129150 | 12.31 | 184650 |
| Skim Milk | 1365000 | 0.11 | 1500 | 3.1 | 42315 | 5.1 | 69451 | 0.74 | 10014 | 8.92 | 121780 | 9.03 | 123280 |
| Cream | 135000 | 40 | 54000 | 2.1 | 2850 | 3 | 4050 | 0.36 | 486 | 5.47 | 7386 | 45.47 | 61386 |

TABLE 2
Holstein Milk RRO Skim Process (3.2x)

| | Quantity | Fat | | Protein | | Lactose | | Minerals | | SNF | | TS | |
|---|---|---|---|---|---|---|---|---|---|---|---|---|---|
| Ingredient | (lbs) | % | lbs | % | lbs | % | lbs | % | lbs | % | lbs | % | lbs |
| Skim milk | 1365000 | 0.11 | 1551 | 3.1 | 42315 | 5.1 | 69451 | 0.73 | 10014 | 8.92 | 121780 | 9.041 | 123331 |
| RRO Skim | 426562 | 0.36 | 1551 | 9.9 | 42315 | 16.3 | 69451 | 2.4 | 10014 | 28.55 | 121780 | 28.91 | 123331 |
| (28.9 wt % TS) | | | | | | | | | | | | | |
| RRO | 938437 | 0 | | 0 | | 0 | | 0 | | 0 | | 0 | |
| Permeate | | | | | | | | | | | | | |

TABLE 3
Final Products

| Ingredient | Lbs. | Gallons |
|---|---|---|
| Coffee base (RRO concentrate) | 426562.5 | 45572.9 |
| Cream | 135000 | 16503.7 |
| RRO Permeate (Cow water) | 938437.5 | 112928.7 |

All publications cited in the specification are indicative of the level of skill of those skilled in the art to which the presently described subject matter pertains. All of these publications are hereby incorporated by reference herein to the same extent as if each individual publication were specifically and individually indicated as being incorporated by reference.

The present subject matter being thus described, it will be apparent that the same may be modified or varied in many ways. Such modifications and variations are not to be regarded as a departure from the spirit and scope of the present subject matter, and all such modifications and variations are intended to be included within the scope of the following claims.

What is claimed is:

1. A process for producing a concentrated and sterilized composition, comprising:
concentrating a composition comprising milk or a milk product comprising
subjecting the composition to multi-stage recirculating reverse osmosis at a temperature of from greater than 45° F. to 60° F. at a pressure of from 200 psi to 700 psi, wherein water is removed from the composition to produce a concentrated composition; and
sterilizing the concentrated composition comprising
first heating the concentrated composition that is at a temperature of from greater than 45° F. to 60° F. to a first elevated temperature of from 175° F. to 185° F. (and in some cases to 210° F.) within a time period of 45 seconds to produce a first heated composition.

2. The process according to claim 1, wherein the volume of the concentrated composition is no more than 50% of the volume of the composition.

3. The process according to claim 1, wherein the composition is skim milk.

4. The process according to claim 1, further comprising after concentrating, adjusting the total solids content of the concentrated composition.

5. The process according to claim 1, wherein the concentrated composition comprises from 28 wt % to 34 wt % of solids-not-fat (SNF).

6. The process according to claim 1, further comprising after the first heating, second heating the first heated composition from the first elevated temperature to a second elevated temperature.

7. The process according to claim 6, wherein the second heating is to a second elevated temperature of from 283° F. to 295° F. within a time period of less than 6 seconds to produce a second heated composition.

8. The process according to claim 7, further comprising holding the second heated composition at the second elevated temperature for at least 4 seconds.

9. The process according to claim 8, further comprising cooling the second heated composition comprising evaporating the second heated composition.

10. A process for producing a concentrated composition, comprising:
subjecting the composition to multi-stage recirculating reverse osmosis at a temperature of from greater than 45° F. to 60° F. at a pressure of from 200 psi to 700 psi, wherein water is removed from the composition to produce a concentrated composition having a solids-not-fat content of from 28 wt % to 34 wt %.

11. The process of claim 10, further comprising sterilizing the concentrated composition.

12. The process of claim 11, wherein sterilizing comprises first heating the concentrated composition that is at a temperature of from greater than 45° F. to 60° F. to a first elevated temperature of from 175° F. to 185° F. (and in some cases to 210° F.) within a time period of 45 seconds to produce a first heated composition.

13. A concentrated and sterilized composition produced by the process of claim 1.

14. A concentrated and sterilized composition produced by the process of claim 10.
